(19) United States
(12) Patent Application Publication
(10) Pub. No.: US 2007/0236083 A1
(43) Pub. Date: Oct. 11, 2007

(54) Negative pressure supply apparatus for brake booster

(75) Inventors: Yutaka Kawamori, Obu-shi (JP); Sunao Kitamura, Obu-shi (JP); Yoshiki Ito, Obu-shi (JP); Kiyoshi Tsukiji, Obu-shi (JP)

Correspondence Address: OLIFF & BERRIDGE, PLC, P.O. BOX 19928, ALEXANDRIA, VA, 22320, US

(73) Assignee: AISAN KOGYO KABUSHIKI KAISHA, AICHI-KEN (JP)

(21) Appl. No.: 11/725,443

(22) Filed: Mar. 20, 2007

(30) Foreign Application Priority Data
Apr. 10, 2006 (JP) 2006-107259

(51) Int. Cl. B60T 13/46

(52) U.S. Cl. 303/114.3; 303/12

(57) ABSTRACT

A negative pressure supply apparatus for brake booster, arranged to supply an intake-pipe negative pressure in an engine intake system to a brake booster mounted in a vehicle, comprises a negative pressure supply part communicated with a bypass passage which allows part of air flowing in the intake pipe to bypass the intake pipe and supplies the intake-pipe negative pressure to the brake booster; an air ejector part placed in the bypass passage to increase the intake-pipe negative pressure and supply the increased negative pressure to the brake booster; and an open/close device including a temperature-sensitive medium, the device being placed in the bypass passage upstream of the air ejector part and configured to open and close the bypass passage.

### BACKGROUND OF THE INVENTION

1. Field of the Invention

The present invention relates to a negative pressure supply apparatus for brake booster, arranged to supply a negative pressure produced in an intake pipe of an engine intake system to a brake booster mounted in a vehicle.

2. Description of Related Art

In general, a brake master cylinder constituting a vehicle brake system is provided with a boosting device, namely, a brake booster. This brake booster is configured to operate by using a negative pressure (vacuum) produced in an intake pipe (hereinafter, “intake-pipe negative pressure”) of an engine intake system. The intake-pipe negative pressure varies according to an operating condition of an engine. Accordingly, during an engine warm-up period, the brake booster can obtain a sufficient intake-pipe negative pressure to operate, whereas, during an engine cold period, it may not obtain a sufficient negative pressure to operate.

Emission restrictions having been increased in recent years. For countermeasures thereto, it is necessary to enhance performance of cleaning exhaust gas by promptly activating a catalytic converter during the engine cold period. To prompt the activation of the catalyst, ignition timing is controlled to delay during the engine cold period. Thus, a sufficient intake-pipe negative pressure may not be supplied to the brake booster during the engine cold period.

Under those circumstances, conventionally proposed negative pressure supply apparatuses for brake booster are configured to always supply a sufficient intake-pipe negative pressure to operate a brake booster. One of them is disclosed in JP-A-2004-243837. This negative pressure supply apparatus for brake booster is provided with a negative pressure responsive valve in an air intake passage of an air ejector. This apparatus is arranged to open the negative pressure responsive valve when the intake-pipe negative pressure is lower than a predetermined value, bringing the air ejector in an operating state to increase the intake-pipe negative pressure, and supply the increased negative pressure to the brake booster, and alternatively close the negative pressure responsive valve when the intake-pipe negative pressure is higher than a predetermined value, stopping the operation of the air ejector and directly supplying the intake-pipe negative pressure to the brake booster.

The aforementioned negative pressure supply apparatus for brake booster therefore needs to have a negative pressure chamber for activating the negative pressure responsive valve, a passage for bringing the negative pressure chamber into communication with a downstream side of the air ejector, and a passage for bringing the negative pressure chamber into communication with an intake pipe downstream of a throttle valve. Thus, the configuration of such apparatus is likely to become complicated.

Further, because of the use of a diaphragm as the negative pressure responsive valve, which is large and heavy, the negative pressure supply apparatus tends to increase in size and weight.

Each of the conventional brake-booster negative pressure supply apparatuses including the above disclosed one is singly fixed to a vehicle. It is therefore necessary to provide a fixing member for the negative pressure supply apparatus and a pipe for connecting the intake pipe and the negative pressure supply apparatus.

### BRIEF SUMMARY OF THE INVENTION

The present invention has an object to provide a negative pressure supply apparatus for brake booster, having a simple structure without causing an increase in size and weight and being able to supply a sufficient intake-pipe negative pressure even during an engine cold period.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a negative pressure supply apparatus for brake booster, arranged to supply an intake-pipe negative pressure in an engine intake system to a brake booster mounted in a vehicle, the apparatus comprising: a negative pressure supply part communicated with a bypass passage which allows part of air flowing in the intake pipe to bypass the intake pipe and supplies the intake-pipe negative pressure to the brake booster; an air ejector part placed in the bypass passage and configured to increase the intake-pipe negative pressure and supply the increase negative pressure to the brake booster; and an open/close device including a temperature-sensitive medium, the device being placed in the bypass passage upstream of the air ejector part and configured to open and close the bypass passage.

According to another aspect, the present invention provides a negative pressure supply apparatus for brake booster, arranged to supply an intake-pipe negative pressure in an engine intake system to a brake booster mounted in a vehicle, the apparatus comprising: a negative pressure supply part communicated with a bypass passage which allows part of air flowing in the intake pipe to bypass the intake pipe and supplies the intake-pipe negative pressure to the brake booster; an air ejector part placed in the bypass passage and configured to increase the intake-pipe negative pressure and supply the increase negative pressure to the brake booster; and an open/close device including a temperature-sensitive medium, the device being placed in the bypass passage upstream of the air ejector part and configured to open and close the bypass passage, the negative pressure supply part, the air ejector part, and the open/close device being integral with a throttle body including a throttle valve.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a schematic configuration view of a negative pressure supply apparatus for brake booster of a first embodiment;

FIG. 2 is a plan view showing a shape of a valve chamber of an open/close valve;

FIG. 3 is a sectional view showing a schematic structure of the open/close valve (an open state) during an engine cold period;

FIG. 4 is a sectional view showing a schematic structure of the open/close valve (a closed state) during an engine warm-up period;

FIG. 5 is an external view of a throttle valve control unit integral with the negative pressure supply apparatus for brake booster;

FIG. 6 is a partly sectional view of the throttle valve control unit integral with the negative pressure supply apparatus for brake booster;

FIG. 7 is a view showing a modification of the negative pressure supply apparatus for brake booster of the first embodiment;

FIG. 8 is a sectional view showing a schematic structure of an open/close valve (an open state) using a shape-memory alloy during an engine cold period;

FIG. 9 is a plan view showing a shape of a valve body shown in FIG. 8; and

FIG. 10 is a sectional view showing a schematic structure of the open/close valve (a closed state) using the shape-memory alloy during an engine warm-up period.

### DETAILED DESCRIPTION OF THE PREFERRED EMBODIMENTS

### First Embodiment

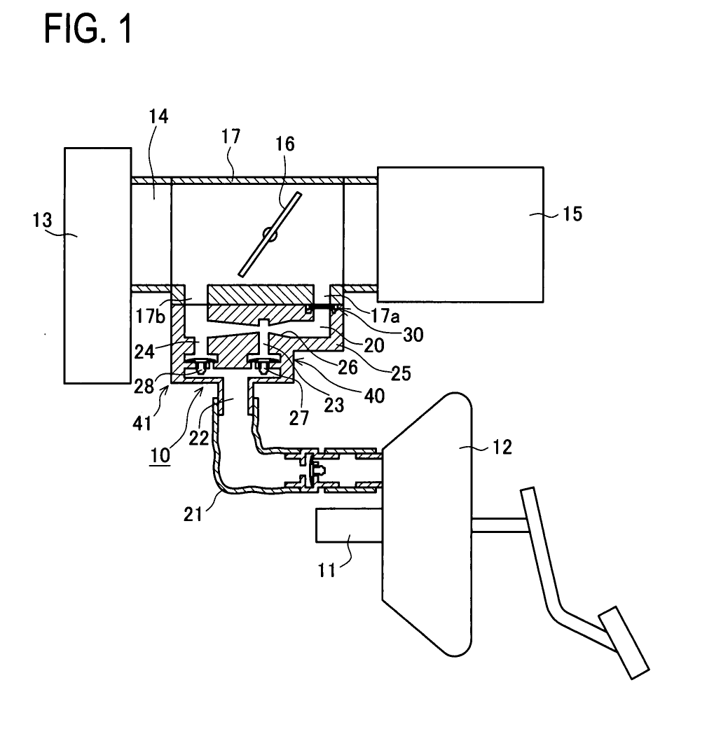

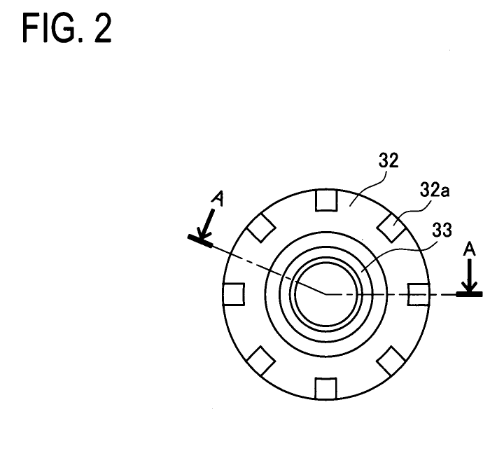

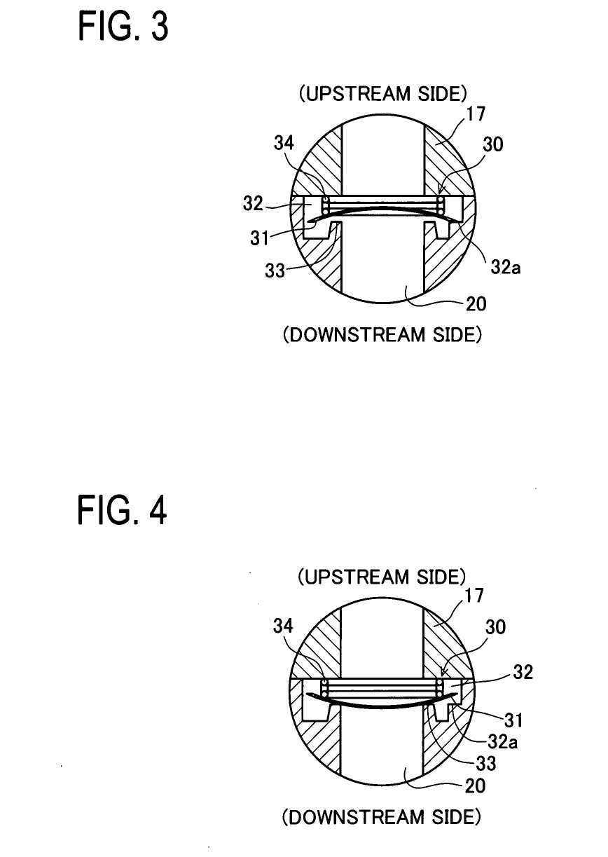

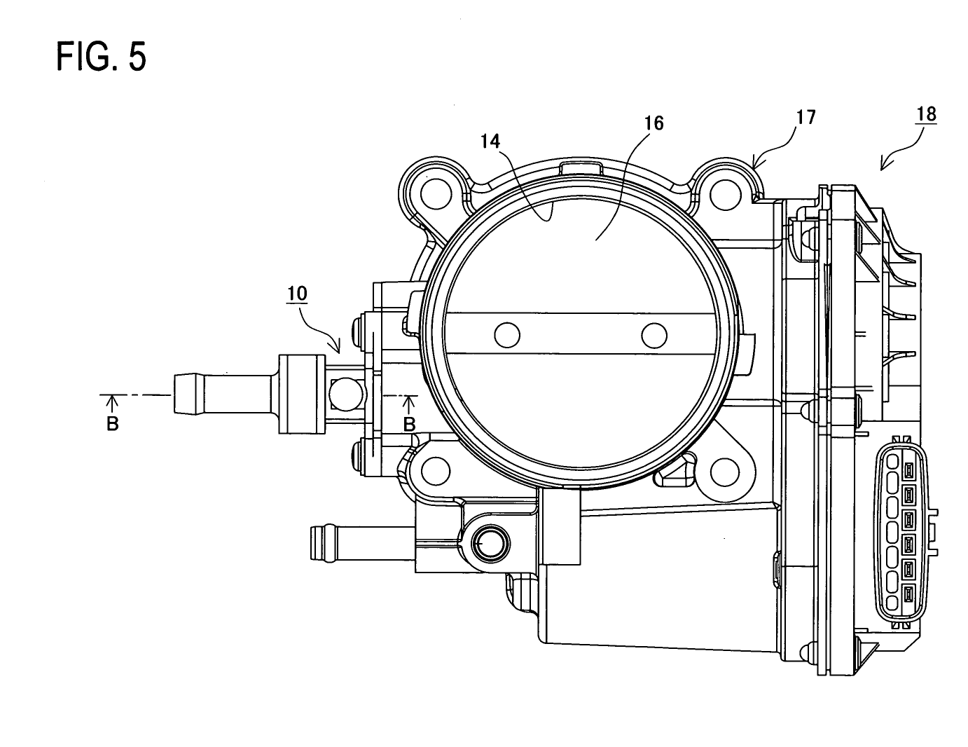

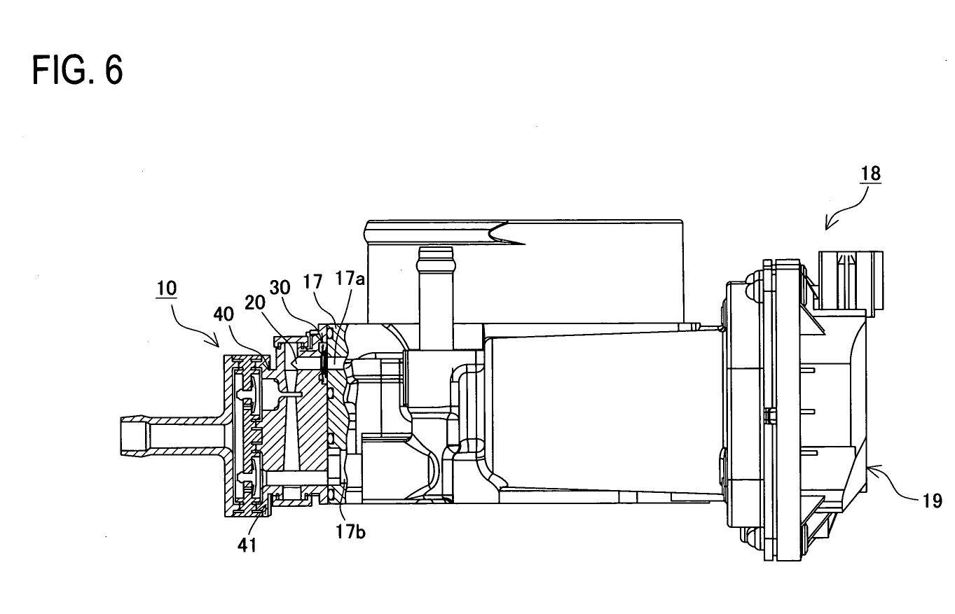

A detailed description of a first preferred embodiment of a negative pressure supply apparatus for brake booster (hereinafter, simply referred to as “negative pressure supply apparatus”) embodying the present invention will now be given referring to the accompanying drawings. Referring to FIGS. 1 through 6, the negative pressure supply apparatus of the present embodiment will be explained. FIG. 1 is a schematic configuration view of the negative pressure supply apparatus of the present embodiment; FIG. 2 is a plan view showing a shape of a valve chamber of an open/close valve; FIG. 3 is a sectional view showing a schematic structure of the open/close valve (an open state) during an engine cold period; FIG. 4 is a sectional view showing a schematic structure of the open/close valve (a closed state) during an engine warm-up period; FIG. 5 is an external view of a throttle valve control unit integral with the negative pressure supply apparatus; and FIG. 6 is a partly sectional view of the throttle valve control unit integral with the negative pressure supply apparatus.

The negative pressure supply apparatus 10 is configured to supply a negative pressure (“intake-pipe negative pressure”) produced in an intake pipe 14 constituting an intake system of an engine 13 to a brake booster 12 attached to a brake master cylinder 11 mounted in a vehicle, as shown in FIG. 1. This negative pressure supply apparatus 10 includes a housing 25 formed with a bypass passage 20 for allowing part of the air flowing in the intake pipe 14 to bypass the intake pipe 14, an air aspiration passage 22 communicated with the booster 12 via an air aspiration pipe 21, and a first and second communication passages 23 and 24 thereby providing communication between the bypass passage 20 and the air aspiration passage 22.

The bypass passage 20 is connected with communication passages 17a and 17b formed in a throttle body 17 communicating with the intake pipe 14. Specifically, the passage defined by the bypass passage 20 and communication passages 17a and 17b correspond to a “bypass passage” of the present invention. An entrance (the communication passage 17a) of the bypass passage 20 is located between an air cleaner 15 attached to one end of the intake pipe 14 and a throttle valve 16 provided in the intake pipe 14. An exit (the communication passage 17b) of the bypass passage 20 is located between the throttle valve 16 and the engine 13.

The bypass passage 20 includes a restricted portion 26 which is formed by a tapered inner wall surface to have a sectional area gradually decreasing toward the center of the bypass passage 20. A part of the restricted portion 26 having the minimum sectional area is communicated with the first communication passage 23. In this passage 23, a first check valve 27 is placed. When this first check valve 27 is opened, the restricted portion 26 is allowed to communicate with the air aspiration passage 21 via the first communication passage 23.

When the air flows in the bypass passage 20, a negative pressure is generated in the bypass passage 20 and increased by the flow of air in passing the restricted portion 26. Thus, the increased negative pressure larger than the intake-pipe negative pressure in the intake pipe 14 downstream of the throttle valve 16 will act on the first check valve 27. This valve 27 is thus opened to allow the increased negative pressure to be supplied to the brake booster 12 via the first communication passage 23, the air aspiration passage 22, and the air aspiration pipe 21. Specifically, the bypass passage 20, the restricted portion 26, and the first communication passage 23 constitute an air ejector part 40.

A second communication passage 24 is provided downstream of the restricted portion 26. In this second communication passage 24, a second check valve 28 is placed. When this second check valve 28 is opened, the bypass passage 20 is allowed to communicate with the air aspiration passage 22 via the second communication passage 24. When the second check valve 28 comes into an open state, the intake-pipe negative pressure in the intake pipe 14 downstream of the throttle valve 16 is directly supplied to the brake booster 12 via the bypass passage 20, the second communication passage 24, the air aspiration passage 22, and the air aspiration pipe 21. Specifically, the bypass passage 20 and the second communication passage 24 constitute a negative pressure supply part 41.

In the bypass passage 20 upstream of the restricted portion 26, an open/close valve 30 is provided to make an ON/OFF control of the operation of the air ejector part 40 by opening and closing the bypass passage 20. This open/close valve 30 is configured to open and close by a temperature sensitive medium, which is a bimetal in the present embodiment.

As shown in FIGS. 3 and 4, the open/close valve 30 includes a dish-shaped bimetal 31 serving as a valve body placed in a valve chamber 32 formed with a plurality of (eight in the present embodiment) protrusions 32a arranged at the bottom at predetermined intervals as shown in FIG. 2. FIGS. 3 and 4 show sectional views taken along a line A-A in FIG. 2. In the valve chamber 32 on the downstream side, a valve seat 33 is formed in an area communicating with the bypass passage 20. The bimetal 31 will be brought into or out of contact with this valve seat 33. A spring 34 is placed on a surface of the bimetal 31 opposite the valve seat 33. This spring 34 presses the outer peripheral portion of the bimetal 31 to the protrusions 32a spaced at the regular intervals at the bottom of the valve chamber 32, thus retaining the bimetal 31 in the valve chamber 32.

Accordingly, when the bimetal 31 is out of contact with the valve seat 33 as shown in FIG. 3, the upstream side and the downstream side of the valve chamber 32 are communicated with each other through spaces between the protrusions 32a, so that the open/close valve 30 is in an open state. As shown in FIG. 4, on the other hand, when the bimetal 31 is in contact with the valve seat 33, the communication between the upstream side and the downstream side of the valve chamber 32 is interrupted by the bimetal 31, so that the open/close valve 30 is in a closed state.

The bimetal 31 is configured to take a convex form on the upstream side, thus coming apart from the valve seat 33 as shown in FIG. 3 while the throttle body 17 is in a temperature range corresponding to the cold period that the water temperature of the engine 13 is about 40° C. or less, whereas to take a concave (reversely warped) form on the downstream side, thus coming into contact with the valve seat 33 as shown in FIG. 4 while the throttle body 17 is in a temperature range corresponding to the warm-up period that the water temperature of the engine 13 exceeds about 40° C. In this manner, the open/close valve 30 will open the bypass passage 20 during the cold period of the engine 13 and close the bypass passage 20 during the warm-up period of the engine 13.

The aforementioned opening/closing of the bypass passage 20 may also be performed by a solenoid valve or a diaphragm. However, the use of the solenoid valve requires not only the solenoid valve itself but also wiring and a control device thereof, which results in a complicated structure and an increased cost.

Alternatively, the use of the diaphragm valve, needing no wiring and control device, may provide a simple structure at low cost as compared with the use of the solenoid valve. However, in the case of using the diaphragm valve, it is necessary to provide another passage (including a negative pressure chamber) in addition to a bypass passage in order to produce a differential pressure for operating the diaphragm. Further, the diaphragm has to be of a predetermined size enough for accurately operating. This makes it difficult to reduce the size and weight.

On the other hand, the aforementioned open/close valve 30 including the bimetal 31 placed in the valve chamber 32 and the spring 34 retaining the bimetal 31 is more simple in structure and low in number of parts as compared with the solenoid valve and the diaphragm valve. The open/close valve 30 can therefore be manufactured to be compact and lightweight, and at low cost.

The use of the open/close valve 30 adopting the bimetal 31 makes it possible to simplify the structure of the negative pressure supply apparatus 10 for making the ON/OFF control of operation of the air ejector part 40.

As shown in FIG. 5, the negative pressure supply apparatus 10 is integrally assembled with the well known throttle valve control unit 18 provided with the throttle body 17 including a part of the intake pipe 14 of the engine 13, the throttle valve 16 rotatably supported in the throttle body 17, and a driving mechanism (motors, gears, etc.) for driving (opening and closing) the throttle valve 16. Specifically, as shown in FIG. 6, the housing 25 is mounted in the throttle body 17 through a sealing member so that the bypass passage 20 formed in the housing 25 is connected with the communication passages 17a and 17b formed in the throttle body 17. The negative pressure supply part 41, the air ejector part 40, and the open/close valve 30 are integral with the throttle body 17 on a side opposite from a side attached with a cover 19. The cross sectional portion in FIG. 6 corresponds to a section taken along a line B-B in FIG. 5.

Since the negative pressure supply apparatus 10 is integrally assembled with the throttle body 17 as above, the operation of the open/close valve 30 can be controlled by heat transferred from a hot-water pipe provided in the throttle body 17. Accordingly, the open/close control of the open/close valve 30 can be performed with accuracy according to the condition of the engine 13 (whether during the cold period or during the warm-up period).

The negative pressure supply apparatus 10 does not have to be installed as a single unit as conventionally. This can eliminate the need for a fixing member required for the conventional apparatus. Further, a pipe is no longer needed for connecting the negative pressure supply apparatus and the intake pipe. Accordingly, the total weight and manufacturing cost of the negative pressure supply apparatus 10 can be reduced. Because there is no need to provide a pipe to the negative pressure supply apparatus 10, the bypass passage 20 is reduced in length, thereby decreasing pressure loss. This makes it possible to enhance the performance of the negative pressure supply apparatus 10.

The following explanation is made on the operation of the negative pressure supply apparatus 10 having the above structure. During the cold period of the engine 13, the bimetal 31 provided in the open/close valve 30 is convex on the upstream side and apart from the valve seat 33, bringing the bypass passage 20 into the open state. Part of the air flowing from the air cleaner 15 into the intake pipe 14 toward the throttle valve 16 is allowed to flow in the bypass passage 20 and then into part of the intake pipe 14 located downstream of the throttle valve 16. This brings the air ejector part 40 located in a portion of the bypass passage 20 is placed in an operating state, increasing the intake-pipe negative pressure.

The increased intake-pipe negative pressure acts on the first check valve 27 to open it. Thus, the increased intake-pipe negative pressure is supplied to the brake booster 12 via the first communication passage 23, the air aspiration passage 22, and the air aspiration pipe 21.

The negative pressure supply apparatus 10, as mentioned above, can supply the increased intake-pipe negative pressure to the brake booster 12. Accordingly, even when the ignition timing is delayed in order to enhance activation of the catalytic medium during the cold period, resulting in a decreased in the intake-pipe negative pressure, a sufficient intake-pipe negative pressure to operate the brake booster 12 can be supplied thereto.

During the warm-up period that the water temperature exceeds about 40° C., the bimetal 31 of the open/close valve 30 is reversely warped to become convex on the downward side, coming into contact with the valve seat 33. This open/close valve 30 brings the bypass passage 20 into a closed state. Accordingly, the air flowing from the air cleaner 15 into the intake pipe 14 toward the throttle valve 16 is not allowed to flow in the bypass passage 20. This brings the air ejector part 40 located in a portion of the bypass passage 20 into an operation stopped state. At this time, the intake-pipe negative pressure causes the second check valve 28 to open. By the negative pressure supply part 41, accordingly, the intake-pipe negative pressure is directly supplied to the brake booster 12 via the air aspiration passage 22 and the air aspiration pipe 21. This makes it possible to block flowing of excess air into the engine 13 during the warm-up period, thereby preventing a deterioration in accuracy of the air flow control of the air-fuel ratio control for the engine 13.

As mentioned above, during the cold period of the engine 13, the negative pressure supply apparatus 10 for brake booster of the present embodiment can supply the intake-pipe negative pressure increased by operation of the air ejector part 40 to the brake booster 12. During the warm-up period of the engine 13, on the other hand, the air ejector part 40 can be placed in the operation stopped state. This makes it possible to block flowing of excess air into the engine 13, thereby preventing a deteriorating in accuracy of the air flow control of the air-fuel ratio control for the engine 13.

The open/close valve 30 which causes the bypass passage 20 to open and close, thereby controlling the ON/OFF operation of the air ejector part 40, is constituted of the bimetal 31. Thus, the open/close valve 30 can have a compact and lightweight form and the negative pressure supply apparatus 10 does not have to be provided with any passage (including a negative pressure chamber) except the bypass passage 20. The negative pressure supply apparatus 10 can therefore be configured in a simple structure without causing an increase in size and weight and also to supply a negative pressure sufficient for operation to the brake booster 12 even during the cold period of the engine 13.

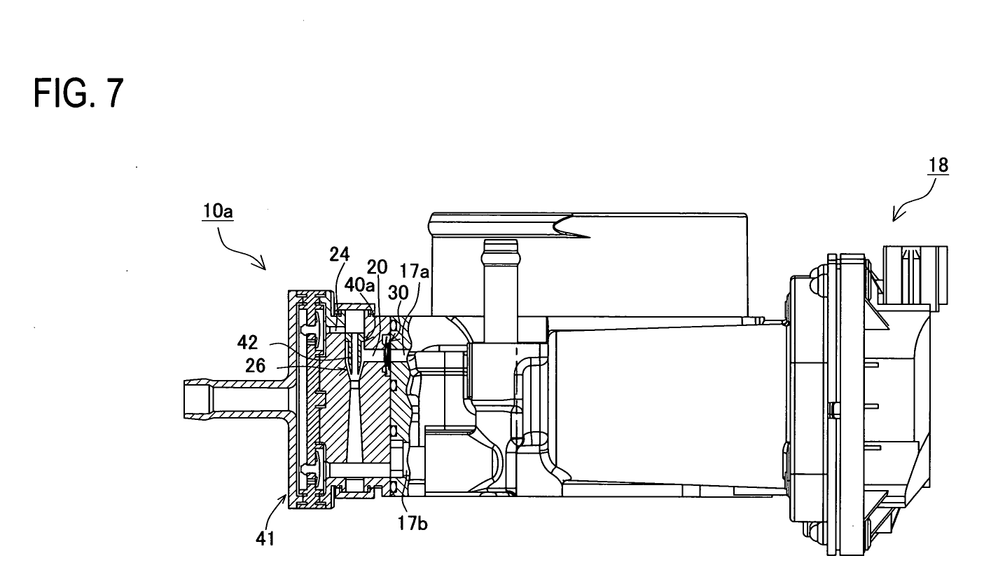

Here, the negative pressure supply apparatus 10 of the first embodiment may be modified into a negative pressure supply apparatus 10a for brake booster, as shown in FIG. 7. FIG. 7 is a view showing a modification of the negative pressure supply apparatus of the first embodiment. This negative pressure supply apparatus 10a includes an air ejector part 40a configured as follows.

Specifically, a cylindrical nozzle 42 whose end having a tapered outer periphery is placed in the restricted portion 26. The outside of this nozzle 42 is communicated with the bypass passage 20, while the inside of the nozzle 42 is communicated with the second passage 24. This forms the air ejector part 40a in a portion of the bypass passage 20, in which a negative pressure will be caused by the flow of air passing a venturi formed between the outer periphery of the end of the nozzle 42 and the restricted portion 26, thereby increasing an intake-pipe negative pressure in the intake pipe 14 downstream of the throttle valve 16.

The negative pressure supply apparatus 10a including the air ejector part 40a configured as above can also provide similar operations and effects to those in the first embodiment.

### Second Embodiment

A second embodiment will be explained below. The basic structure of this embodiment is identical to that of the first embodiment, excepting that an open/close valve using a temperature-sensitive medium made of a shape-memory alloy (SMA) to open and close the bypass passage. Accordingly, the following explanation will be made with a focus on such differences, and identical components to those of the first embodiment are assigned the same reference numerals and the explanation thereof is appropriately omitted.

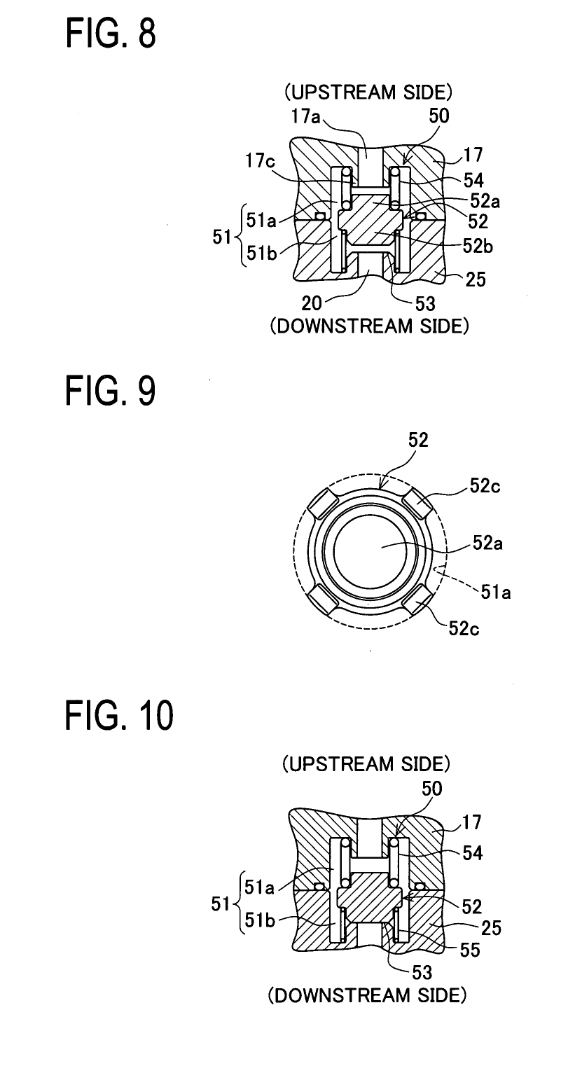

The following explanation is first made on the open/close valve using the shape-memory alloy, which is a different point from the first embodiment, referring to FIGS. 8 to 10. FIG. 8 is a sectional view showing a schematic structure of the open/close valve (an open state) using the shape-memory alloy during the engine cold period. FIG. 9 is a plan view showing the shape of a valve body shown in FIG. 8. FIG. 10 is a sectional view showing a schematic structure of the open/close valve (a closed state) using the shape-memory alloy during the engine warm-up period.

As shown in FIG. 8, an open/close valve 50 for use with a negative pressure supply apparatus for brake booster (hereinafter, simply referred to as “negative pressure supply apparatus”) of the second embodiment is provided with a valve chamber 51 including a first space portion 51a formed in the throttle body 17 and communicated with the communication passage 17a and a second space portion 51b formed in the housing 25 and communicated with the bypass passage 20. In this valve chamber 51, a valve body 52 is placed.

The valve body 52 is formed with a plurality of (four in the present embodiment) guide ribs 52c arranged at circumferentially spaced intervals as shown in FIG. 9, the ribs 52c being slidable on an internal surface of the valve chamber 51. With those guide ribs 52c, the valve body 52 is smoothly moveable up and down within the valve chamber 51 without inclining. The valve body 52 is provided with an upper and lower solid circular protrusions 52a and 52b. An end of a shape-memory alloy member 54 (e.g., a cylindrical, tubular, or spring-like shape) is fitted on the outer periphery of the upper protrusion 52a of the valve body 52, while one end of a spring 55 is fitted on the outer periphery of the lower protrusion 52b. Here, the other end of the shape-memory alloy 54 is fitted on the outer periphery of an annular protrusion 17c formed in a communication area between the communication passage 17a and the first space portion 51a. The other end of the spring 55 is fitted on the outer periphery of a valve seat 53. Accordingly, the valve body 52 is retained in the valve chamber 51 by the shape-memory alloy 54 and the spring 55.

When the valve body 52 is brought out of contact with the valve seat 53 as shown in FIG. 8, the communication passage 17a and the bypass passage 20 is brought into communication with each other through the valve chamber 51. The open/close valve 50 is therefore placed in the open state. When the valve body 52 is brought into contact with the valve seat 53 as shown in FIG. 10, on the other hand, the valve body 52 interrupts the communication between the communication passage 17a and the bypass passage 20. The open/close valve 50 is therefore placed in the closed state.

Here, the shape-memory alloy 54 is configured to contract in height as shown in FIG. 8 while the throttle body 17 is in a temperature range corresponding to the cold period that the water temperature of the engine 13 is about 40° or less, thereby allowing the valve body 52 to move away from the valve seat 53 by an urging force of the spring 55, and configured to expand in height as shown in FIG. 10 while the throttle body 17 is in a temperature range corresponding to the warm-up period that the water temperature of the engine 13 exceeds about 40°, thereby bringing the valve body 52 into contact with the valve seat 53 against the urging force of the spring 55. In this manner, the open/close valve 50 is arranged to open the bypass passage 20 during the cold period of the engine 13 and close the same during the warm-up period of the engine 13.

The above open/close valve 50 is constituted of the valve body 52 provided in the valve chamber 51 and a combination of the shape-memory alloy 54 and the spring 55 which retain the valve body 52. This is a very compact structure with a less number of components as compared with a solenoid valve and a diaphragm valve. The open/close valve 50 therefore can be manufactured in compact and light weight form and also at low cost.

In the negative pressure supply apparatus of the second embodiment, the open/close valve 50 performs the ON/OFF control of the operation of the air ejector part 40. According to the negative pressure supply apparatus of the second embodiment, similar to the first embodiment, the air ejector part 40 can be activated during the cold period of the engine 13 to supply the increased intake-pipe negative pressure to the brake booster 12. During the warm-up period of the engine 13, on the other hand, the air ejector part 40 can be placed in the operation stopped state. This makes it possible to block flowing of excess air into the engine 13, thereby preventing a deterioration in accuracy of the air flow control of the air-fuel ratio control for the engine 13.

The negative pressure supply apparatus of the second embodiment including the open/close valve 50 using the shape-memory alloy 54 can also achieve a simple configuration without causing an increase in size and weight, and capable of supplying a negative pressure sufficient for operation to the brake booster 12.

The present invention may be embodied in other specific forms without departing from the spirit or essential characteristics thereof. For instance, the temperature-sensitive media in the above embodiments are the bimetal and the shape-memory alloy, but may be wax and others. In the aforementioned embodiments, the reference value (criteria) to distinguish between the cold period and the warm-up period of the engine 13 is set to about 40° C., but not limited thereto. This reference value may be different according to the specifications (types, controls methods, etc.) of the engine.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A negative pressure supply apparatus for brake booster, arranged to supply an intake-pipe negative pressure in an engine intake system to a brake booster mounted in a vehicle, the apparatus comprising:
a negative pressure supply part communicated with a bypass passage which allows part of air flowing in the intake pipe to bypass the intake pipe and supplies the intake-pipe negative pressure to the brake booster;
an air ejector part placed in the bypass passage and configured to increase the intake-pipe negative pressure and supply the increase negative pressure to the brake booster; and
an open/close device including a temperature-sensitive medium, the device being placed in the bypass passage upstream of the air ejector part and configured to open and close the bypass passage.

2. The negative pressure supply apparatus for brake booster according to claim 1, wherein the temperature-sensitive medium of the open/close device operates by heat transferred from an engine.

3. The negative pressure supply apparatus for brake booster according to claim 1, wherein the temperature-sensitive medium of the open/close device is a bimetal.

4. The negative pressure supply apparatus for brake booster according to claim 1, wherein the temperature-sensitive medium of the open/close device is a shape-memory alloy.

5. The negative pressure supply apparatus for brake booster according to claim 1, wherein the temperature-sensitive medium of the open/close device is wax.

6. The negative pressure supply apparatus for brake booster according to claim 1, wherein the open/close device is configured to open the bypass passage by the temperature-sensitive medium during a cold period of the engine.

7. A negative pressure supply apparatus for brake booster, arranged to supply an intake-pipe negative pressure in an engine intake system to a brake booster mounted in a vehicle, the apparatus comprising:
a negative pressure supply part communicated with a bypass passage which allows part of air flowing in the intake pipe to bypass the intake pipe and supplies the intake-pipe negative pressure to the brake booster;
an air ejector part placed in the bypass passage and configured to increase the intake-pipe negative pressure and supply the increase negative pressure to the brake booster; and
an open/close device including a temperature-sensitive medium, the device being placed in the bypass passage upstream of the air ejector part and configured to open and close the bypass passage,
the negative pressure supply part, the air ejector part, and the open/close device being integral with a throttle body including a throttle valve.

8. The negative pressure supply apparatus for brake booster according to claim 7, wherein the negative pressure supply part, the air ejector part, and the open/close device are integral with the throttle body on a side opposite from a side attached with a cover.

9. The negative pressure supply apparatus for brake booster according to claim 7, wherein the temperature-sensitive medium of the open/close device operates by heat transferred from an engine.

10. The negative pressure supply apparatus for brake booster according to claim 9, wherein the temperature-sensitive medium of the open/close device operates by heat transferred from a hot-water pipe provided in the throttle body.

11. The negative pressure supply apparatus for brake booster according to claim 7, wherein the temperature-sensitive medium of the open/close device is a bimetal.

12. The negative pressure supply apparatus for brake booster according to claim 7, wherein the temperature-sensitive medium of the open/close device is a shape-memory alloy.

13. The negative pressure supply apparatus for brake booster according to claim 7, wherein the temperature-sensitive medium of the open/close device is wax.

14. The negative pressure supply apparatus for brake booster according to claim 7, wherein the open/close device is configured to open the bypass passage by the temperature-sensitive medium during a cold period of the engine.
